(19) United States
(12) Patent Application Publication
(10) Pub. No.: US 2025/0183746 A1
(43) Pub. Date: Jun. 5, 2025

(54) INSULATION RING, STATOR AND METHOD FOR PRODUCING A STATOR

(71) Applicant: Schaeffler Technologies AG & Co. KG, Herzogenaurach (DE)

(72) Inventors: Michael von Seydlitz, Bühl (DE); Paul Gehrke, Karlsruhe (DE); Florian Müller, Rastatt (DE)

(73) Assignee: Schaeffler Technologies AG & Co. KG, Herzogenaurach (DE)

(21) Appl. No.: 18/839,725

(22) PCT Filed: Dec. 15, 2022
(86) PCT No.: PCT/DE2022/100957

§ 371 Date: Aug. 20, 2024

(30) Foreign Application Priority Data
Feb. 24, 2022 (DE) 10 2022 104 442.4

(51) Int. Cl. H02K 3/38; H02K 15/104

(52) U.S. Cl. CPC H02K 3/38; H02K 15/104

(57) ABSTRACT

An insulation ring for a winding head of a hairpin winding of a stator of an electrical machine within a drivetrain of a motor vehicle includes an annular disc-shaped main body with a plurality of openings that extend axially through the main body and can each be penetrated at least in sections by the free ends of a pair of hairpin conductor rods. At least one spacer element protrudes out of the main body in a first axial direction and at least one retaining element protrudes out of the main body in a second axial direction.

### CROSS-REFERENCE TO RELATED APPLICATIONS

This s application is the U.S. National Phase of PCT Appln. No. PCT/DE2022/100957 filed Dec. 15, 2022, which claims priority to DE 10 2022 104 442.4 filed Feb. 24, 2022, the entire disclosures of which are incorporated by reference herein.

### TECHNICAL FIELD

The present disclosure relates to an insulation ring for a winding head of a hairpin winding of a stator of an electrical machine within a drivetrain of a motor vehicle, wherein the insulation ring has an annular disc-shaped main body with a plurality of openings that extend axially through the main body and can each be penetrated at least in sections by the free ends of a pair of hairpin conductor rods. The disclosure further relates to a stator and a method for producing a stator.

### BACKGROUND

Electric motors are increasingly being used to drive motor vehicles to create alternatives to internal combustion engines that require fossil fuels. Significant efforts have already been made to improve the suitability of electric drives for everyday use and also to be able to offer users the driving comfort which they are accustomed to.

A detailed description of an electric drive can be found in an article in the German automotive magazine ATZ, volume 113, pages 10-14 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. This article describes a drive unit for an axle of a vehicle, which comprises an electric motor that is arranged to be concentric and coaxial with a bevel gear differential, wherein a shiftable 2-speed planetary gear set is arranged in the power train between the electric motor and the bevel gear differential and is also positioned to be coaxial with the electric motor or the bevel gear differential or spur gear differential. The drive unit is very compact and allows for a good compromise between gradability, acceleration and energy consumption due to the shiftable 2-speed planetary gear set. Such drive units are also referred to as e-axles.

In addition to purely electrically operated drivetrains, hybrid drivetrains are also known. Such drivetrains of a hybrid vehicle usually comprise a combination of an internal combustion engine and an electric motor, and enable, for example in urban areas, a purely electric mode of operation while at the same time permitting both sufficient range and availability, in particular when driving cross-country. In addition, drive can also be provided by the internal combustion engine and the electric motor at the same time in certain operating situations.

For the development of electrical machines, in particular electrical machines for the above-mentioned hybrid or fully electric motor vehicles or also for wheel hub drives, fundamentally different winding technologies for a stator of an electrical machine are known.

Electrical machines that have a hollow-cylindrical stator, i.e. are designed as internal rotor machines, and that are configured for use as a traction drive of a motor vehicle often have a stator winding with a rectangular cross-section in order to achieve a high power density. In electrical machines intended for driving motor vehicles, the stator windings are therefore typically designed as hairpin windings. In this case, for example, substantially U-shaped wire segments are introduced into the stator slots from one end face of the stator and then shaped at an opposite end face of the stator and connected, for example, by welding.

In the case of such hairpin windings, it is also known to connect these together with the winding head of the hairpin winding by means of a so-called full potting of the stator to electrically insulate it. However, there is a risk that vibration loads during operation of the electrical machine may lead to cracks in the potting over the service life of the stator. This cracking can then lead to the formation of air and creepage distances and local electrical short circuits, which can have a negative impact on the performance of the electrical machine and is often undesirable.

As an alternative or in addition to full potting, closed caps for insulating the hairpin ends on a winding head of a hairpin winding are also known from the prior art. An example of this is disclosed in JP2000209802A.

### SUMMARY

It is therefore the object of the disclosure to provide an insulation ring for a winding head of a hairpin winding of a stator of an electrical machine within a drivetrain of a motor vehicle which allows reliable and long-lasting insulation of the winding head, which can be produced cost-effectively and is easy to install. It is also the object of the disclosure to realize a stator for an electrical machine within a drivetrain of a motor vehicle which has reliable and durable insulation of a winding head of a hairpin winding. It is a further object of the disclosure to provide a method for producing a stator for an electrical machine within a drivetrain of a motor vehicle by means of which reliable and durable insulation of a winding head can be realized.

This object is achieved by an insulation ring for a winding head of a hairpin winding of a stator of an electrical machine within a drivetrain of a motor vehicle, wherein the insulation ring has an annular disc-shaped main body with a plurality of openings that extend axially through the main body and can each be penetrated at least in sections by the free ends of a pair of hairpin conductor rods, wherein at least one spacer element protrudes out of the main body in a first axial direction and at least one retaining element protrudes out of the main body in a second axial direction.

This provides the advantage that the insulation ring can be placed axially on a stator in a simple manner, wherein the axial distance between the stator and the main body is defined by the at least one spacer element. In other words, the at least one spacer element forms an axial stop of the insulation ring relative to the stator. By means of the at least one retaining element, the insulation ring can be held, for example by means of a corresponding tool, and placed onto the winding head of the hairpin winding.

The individual elements of the claimed subject matter of the disclosure are explained herein, after which advantageous embodiments of the subject matter of the disclosure are described.

The stator according to the disclosure is intended for use in an electrical machine. The electrical machine is used to convert electrical energy into mechanical energy and/or vice versa, and generally comprises a stationary part referred to as a stator or armature, and a part referred to as a rotor, which is arranged movably, in particular rotatably, relative to the stationary part. In particular, the electrical machine is dimensioned such that vehicle speeds of more than 50 km/h, preferably more than 80 km/h, and in particular more than 100 km/h can be achieved. The electric motor particularly preferably has an output of more than 30 kW, preferably more than 50 KW, and in particular more than 70 kW. Furthermore, it is preferred that the electrical machine provides speeds greater than 5000 rpm, particularly preferably greater than 10,000 rpm, very particularly preferably greater than 12,500 rpm.

The stator can in particular be supplied with by a power electronics unit. A power electronics unit is preferably a combination of different components that control or regulate a current to the stator, preferably including the peripheral components required for this purpose, such as cooling elements or power supply units. In particular, the power electronics unit contains one or more power electronics components that are configured to control or regulate a current. These are particularly preferably one or more power switches, such as power transistors. The power electronics unit particularly preferably has more than two, particularly preferably three, phases or current paths which are separate from one another and which each have at least one separate power electronics unit component. The power electronics unit is preferably designed to control or regulate a power per phase with a peak power, preferably continuous power, of at least 10 W, preferably at least 100 W, particularly preferably at least 1000 W. The power electronics unit is preferably connected to the stator winding of the stator via an HV terminal (HV=high voltage).

For the purposes of this application, motor vehicles are land vehicles that are moved by machine power without being bound to railroad tracks. A motor vehicle can be selected, for example, from the group of passenger cars, trucks, small motorcycles, light motor vehicles, motorcycles, motor buses/coaches or tractors.

The stator according to the disclosure can preferably be configured for a radial flux machine. The stator of a radial flux machine usually has a structure which is cylindrical or in the shape of a cylindrical ring and generally consists of a stator body which is formed from electrical steel sheets that are electrically insulated from one another and are structured in layers and packaged to form laminated cores. With this structure, the eddy currents in the stator caused by the stator field are kept low. Distributed around the circumference, stator slots are embedded into the electrical steel sheet running parallel to the rotor shaft and receive the stator winding or parts of the stator winding. Depending on the structure towards the surface, the slots can be closed with closing elements, such as closing wedges or covers or the suchlike, to prevent the stator winding from detaching.

The stator body is preferably designed in one piece. A one-piece stator body is characterized by the fact that the entire stator body is formed in one piece as viewed over the circumference. The stator body is usually formed from a plurality of stacked laminated electrical steel sheets, wherein each of the electrical steel sheets is closed to form a circular ring. The individual laminations can be held together in the stator body, for example by adhesive bonding, welding or screwing.

The stator teeth of the stator are preferably formed in the stator body. Stator teeth are components of the stator body which are designed as circumferentially spaced, tooth-like parts of the stator body directed radially inwards (internal rotor) or radially outwards (external rotor) and between the free ends of which and a rotor body an air gap for the magnetic field and for the rotative movement of the rotor is formed. The non-magnetic gap between the rotor and the stator is referred to as the air gap. In a radial flux machine, for example, this is a substantially annular gap with a radial width that corresponds to the distance between the rotor body and the stator body.

A stator winding is embedded in the stator slots of the stator according to the disclosure. A stator winding comprises electrically conductive conductors which have a longitudinal extension that is much greater than their diameter. The stator winding can generally have any cross-sectional shape. Rectangular cross-sectional shapes are preferred since these allow high packing densities and consequently high power densities to be achieved. Particularly preferably, a stator winding is formed of copper. According to the disclosure, the stator winding is designed as a hairpin winding.

Preferably, the insulation ring is made of a material that is not electrically conductive or at least only weakly conductive. The insulation ring can be formed, for example, of a ceramic or plastic. The plastic is preferably a fiber-reinforced plastic. Most preferably, the insulation ring is formed from a plastic by means of an injection molding process.

The openings of the insulation ring are preferably arranged along concentrically extending diameters in the annular disc-shaped main body. Furthermore, the openings are preferably positioned equidistantly from one another on a diameter. In this context, it is further preferable that the openings are positioned on the concentrically extending diameters in circumferentially distributed groups of openings arranged radially in alignment with one another. In this regard, it is also highly preferable that radially aligned openings of a group are spaced equidistantly from one another. It is also highly preferable that the openings are substantially identical in shape. In this case, it may be preferred that an opening is formed substantially rectangularly with rounded corners and that its longitudinal extension is oriented in the circumferential direction of the insulation ring.

The insulation ring can be designed integrally or in several parts. Preferably, the main body of the insulation ring is formed integrally, more preferably monolithically. However, it would also be possible for the insulation ring to be formed from a plurality of ring segments that are connected to one another integrally, frictionally and/or form-fittingly.

It may further be preferred that the at least one spacer element is formed integrally, preferably monolithically, with the main body. In principle, it would also be conceivable for the spacer element to be made of a material that differs from the material of the main body. It would also be possible to design the spacer element as a component which is separate from the main body and which is connected form-fittingly, frictionally and/or integrally to the main body.

The retaining element can preferably be formed integrally, in particular monolithically, with the main body of the insulation ring. In principle, it would also be conceivable for the retaining element to be made of a material that differs from the material of the main body. It would also be possible to design the retaining element as a component which is separate from the main body and which is connected form-fittingly, frictionally and/or integrally to the main body.

According to an advantageous embodiment of the disclosure, the insulation ring can have at least three spacer elements and/or at least three retaining elements. The advantage of this design is that it can provide statically defined supports or contacts that prevent unintentional tilting of the insulation ring, for example on the end surface of the stator. According to a further preferred development of the disclosure, it is also possible for the spacer elements and/or the retaining elements to be arranged equidistantly along the circumference of the insulation ring, which further increases the tilt resistance of the insulation ring.

The at least three spacer elements can be designed as protrusions. Preferably, the spacer elements are designed in the form of circular ring shell segments. Furthermore, the spacer elements are preferably arranged on the radially outer diameter of the annular disc-like main body. It may also be preferable for the spacer elements to extend in a trapezoidal-like manner in the axial direction, with the long trapezoid side facing the main body and the short trapezoid side facing the stator. Most preferably, the at least three spacer elements are formed identically. According to a further, highly preferable embodiment of the disclosure, the insulation ring has exactly three spacer elements. All these measures can support the lightweight construction of the electrical machine in that the spacer elements are designed only for the axial positioning of the insulation ring relative to the stator.

The at least three retaining elements can be designed as protrusions. Preferably, the protrusions are cylindrical in shape. Furthermore, the retaining elements are preferably arranged on the radially outer diameter of the annular disc-like main body. Most preferably, the at least three retaining elements are formed identically. According to a further, highly preferable embodiment of the disclosure, the insulation ring has exactly three retaining elements. All these measures can support the lightweight construction of the electrical machine, as the retaining elements are designed only for the axial and circumferential positioning of the insulation ring relative to a tool.

Furthermore, according to a likewise advantageous embodiment of the disclosure, the spacer elements and the retaining elements can each form pairs assigned to one another, which are each positioned in a common circumferential segment of the insulation ring.

The object of the disclosure is further achieved by a stator for an electrical machine within a drivetrain of a motor vehicle, wherein the stator is designed in the shape of a cylindrical ring and a winding head of a hairpin winding extends axially out of the stator at at least one axial end face, wherein the free ends of a plurality of pairs of hairpin conductor rods are received in openings of an insulation ring, wherein at least these openings are filled with a preferably electrically insulating potting compound and the insulation ring bears against the axial end face of the stator via the at least one spacer element extending axially out of the main body of the insulation ring, without torques being transferable between the insulation ring and the stator.

This has the particular effect that no vibrations are transferred to the insulation ring in the circumferential direction during operation of the stator, which means that the insulation of the hairpin winding head can be made significantly more durable and resistant to unwanted cracking. Even if cracks occur in the potting compound, the insulation ring helps reduce the spread of these cracks, and further damage caused by leakage current can be prevented or reduced.

Furthermore, the disclosure can also be further developed in such a way that the at least one spacer element has no potting compound on its section contacting the stator, which can also contribute to a lightweight construction of the stator.

In a likewise preferred embodiment of the disclosure, it is also possible for the at least one retaining element of the insulation ring to project out of the potting compound in the axial direction or at least not be covered by potting compound in the circumferential direction.

It may also be advantageous to further develop the disclosure in such a way that the insulation ring is fixed in relation to the hairpin winding only via the potting compound in the circumferential direction, in the radial direction and in an axial direction, which also prevents or at least reduces the risk of unwanted cracking and the formation of electrical creepage distances.

The object of the disclosure is finally also achieved by a method for producing a stator for an electrical machine within a drivetrain of a motor vehicle, comprising the following steps:
providing a stator, wherein the stator is in the shape of a cylindrical ring and a winding head of a hairpin winding extends axially out of the stator at at least one axial end face,
providing an insulation ring, in particular an insulation ring, the insulation ring having an annular disc-shaped main body with a plurality of openings that extend axially through the main body, as well as a spacer element extending out of the main body at least in a first axial direction and at least one retaining element extending out of the main body in a second axial direction,
placing the insulation ring on the winding head of the hairpin winding so that the openings are each penetrated at least in sections by the free ends of a pair of hairpin conductor rods, and the insulation ring bears against the axial end face of the stator via the at least one spacer element extending axially out of the main body of the insulation ring, without torques being transferable between the insulation ring and the stator,
fixing a potting tool in relation to the at least one retaining element of the insulation ring in the axial direction and the circumferential direction,
filling the openings with a potting compound using the potting tool,
removing the potting tool from the at least one retaining element.

Finally, the method according to the disclosure can also be advantageously designed such that the fixing of the potting tool in relation to the at least one retaining element of the insulation ring in the axial direction and circumferential direction takes place before the insulation ring is placed on the winding head of the hairpin winding, such that the insulation ring is placed on the winding head by the potting tool.

### BRIEF DESCRIPTION OF THE DRAWINGS

The disclosure is explained in more detail below with reference to figures without limiting the general concept of the disclosure.

In the drawings:

FIG. 1 shows an insulation ring in a perspective view;

FIG. 2 shows a perspective view of a stator with an insulation ring placed on the winding head of a hairpin winding;

FIG. 3 shows a detailed view of the insulation ring placed on the winding head of the hairpin winding in a perspective view;

FIG. 4 shows a perspective view of a stator with an insulation ring placed and cast on the winding head of a hairpin winding;

FIG. 5 shows a hybrid and a fully electric motor vehicle in a schematic block diagram.

### DETAILED DESCRIPTION

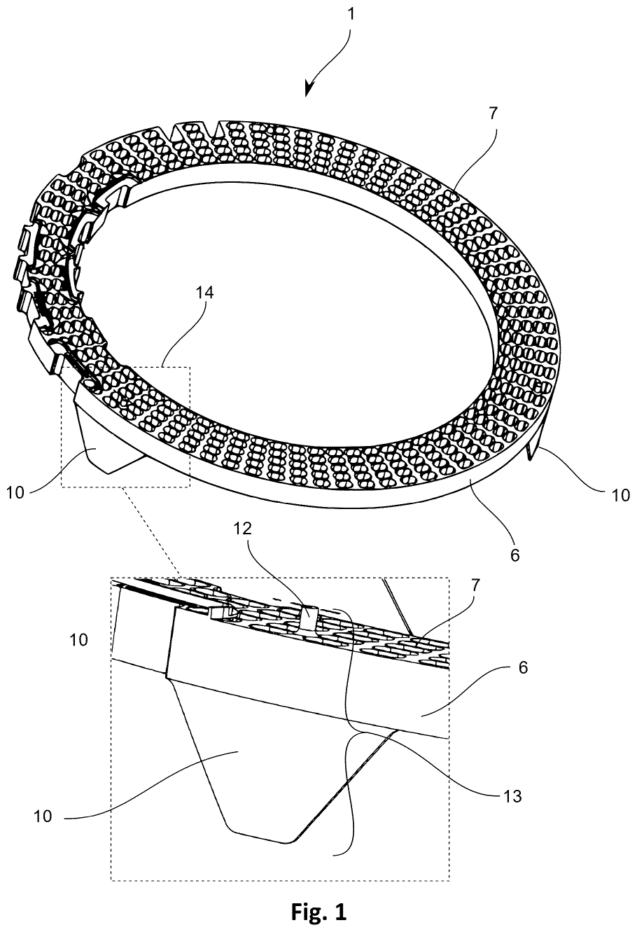

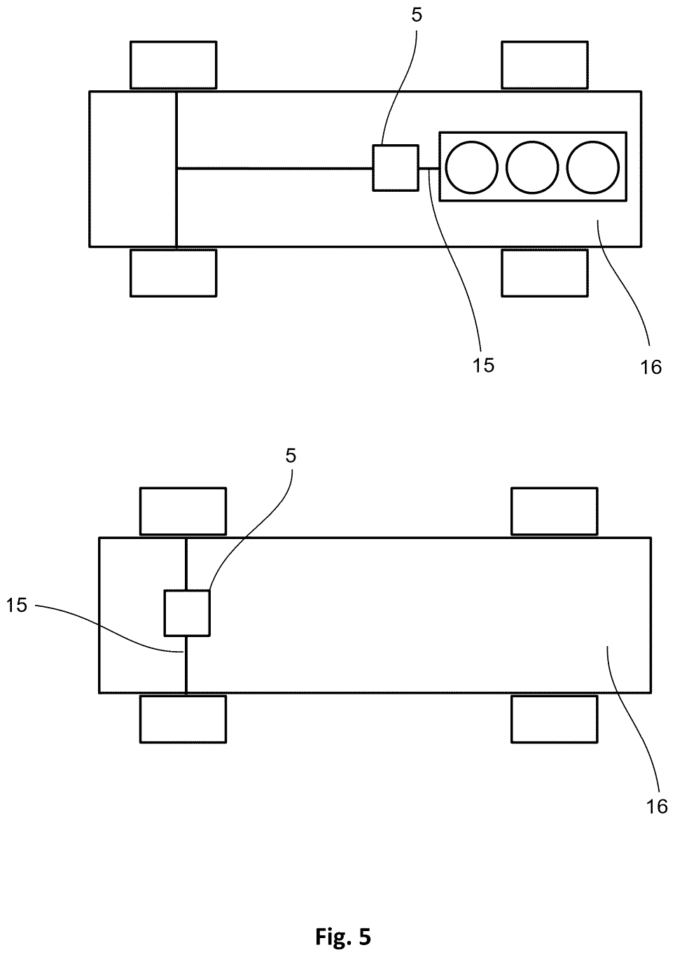

FIG. 1 shows an insulation ring 1 for a winding head 2 of a hairpin winding 3 of a stator 4 of an electrical machine 5, as used, for example, within a drivetrain 15 of a motor vehicle 16, which is outlined by way of example in FIG. 5.

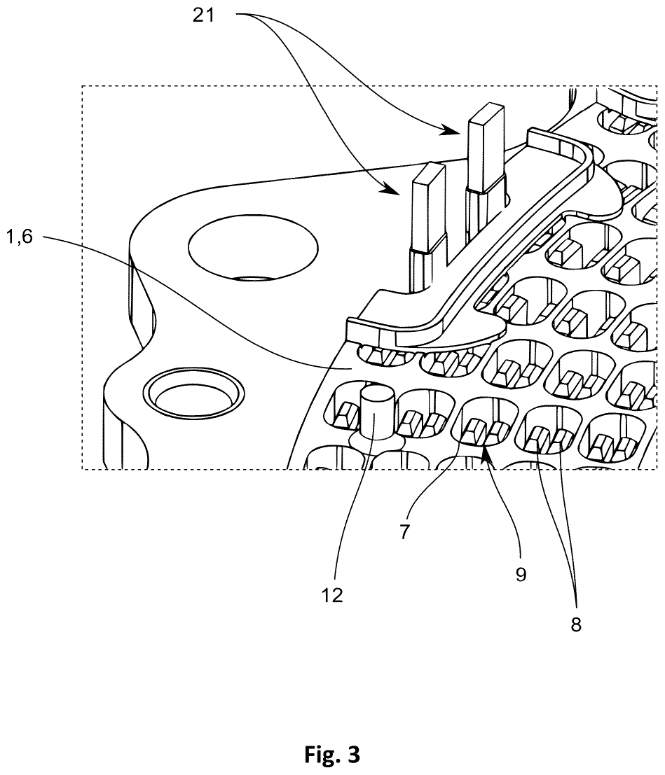

The insulation ring 1 has an annular disc-shaped main body 6 with a plurality of openings 7 that extend axially through the main body 6 and can each be penetrated at least in sections by the free ends 8 of a pair of hairpin conductor rods 9, which can be clearly seen when viewed together with FIG. 3.

Three spacer elements 10 extend in a first axial direction and three retaining elements 12 extend in a second axial direction out of the main body 6.

The spacer elements 10 and the retaining elements 12 are arranged equidistantly along the circumference of the insulation ring 1. In the embodiment shown, the spacer elements 10 and the retaining elements 12 each form pairs 13 assigned to one another, which are each positioned in a common circumferential segment 14 of the insulation ring 1. The insulation ring 1 is formed in one piece from a plastic by means of an injection molding process.

The openings 7 of the insulation ring 1 are arranged along concentrically extending diameters in the annular disc-shaped main body 6. On a diameter, the openings 7 are positioned equidistantly from each other. It can also be clearly seen from FIG. 1 that the openings 7 are positioned on the concentrically extending diameters in circumferentially distributed groups of openings 7 arranged radially in alignment with one another, the radially aligned openings 7 of a group also being spaced equidistantly from one another.

In the embodiment shown, the openings 7 are formed substantially identically rectangularly with rounded corners, wherein their longitudinal extension is oriented in the circumferential direction of the insulation ring 1. The design of the openings 7 is chosen such that the pairs of hairpin conductor rods 9 received in an opening 7 ideally do not contact the opening 7 so that potting compound 18 can ensure complete insulation in each case between the pairs of hairpin conductor rods 9 and the openings 7. In other words, the insulation ring 1 has no contact with the winding head 2.

The spacer elements 10 and the retaining elements 12 are formed monolithically with the main body 6.

The three spacer elements 10 are designed as protrusions which are arranged on the radially outer diameter of the annular disc-like main body. These spacer elements 10 extend in the axial direction in a trapezoidal shape, with the long trapezoid side facing the main body 6 and the short trapezoid side facing the stator 4. The three spacer elements 10 are formed in equal parts.

The three retaining elements 12 are also designed as protrusions, but have a cylindrical design and are arranged on the radially outer diameter of the annular disc-like main body 6. The three retaining elements 12 are formed in equal parts.

The underside of the main body 6 can have a slight slope so that when the potting compound 18 is poured in from below, no gas bubbles remain on or in the main body 6.

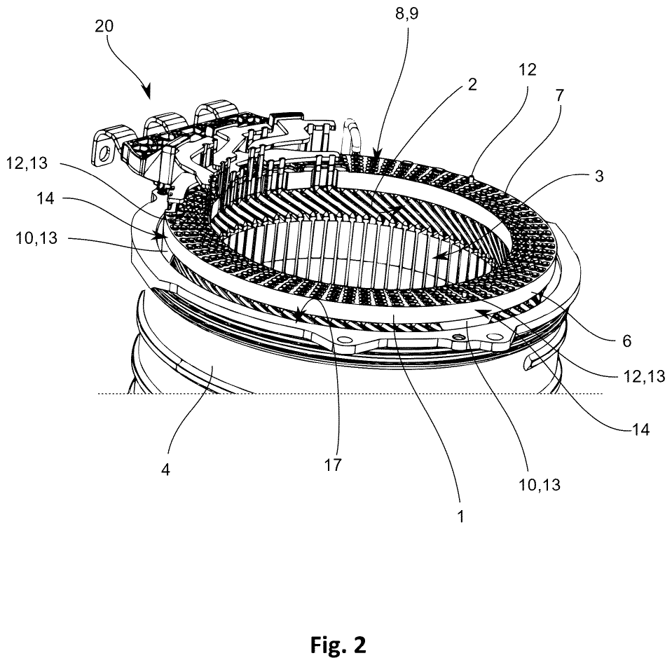

FIG. 2 shows a stator 4 for an electrical machine 5, as used, for example, within a drivetrain 15 of a motor vehicle 16. The stator 4 is in the shape of a cylindrical ring and a winding head 2 of a hairpin winding 3 extends axially out of the stator 4 at at least one axial end face 17. The hairpin winding 3 can be connected via the HV terminal 20 to a power electronics unit for supplying current to the hairpin winding 3. This connection is made via HV connection pins 21 of the hairpin winding 3 that project axially from the winding head 2, as shown in FIG. 3.

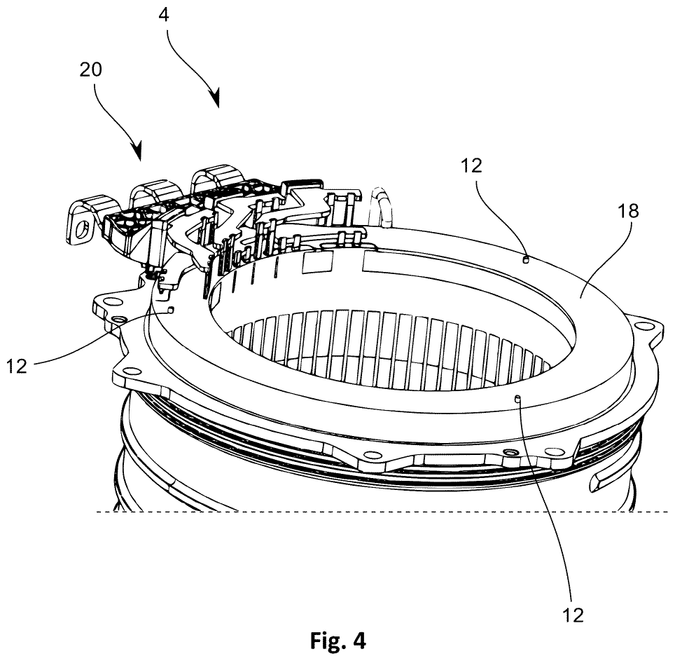

The free ends 8 of a plurality of pairs of hairpin conductor rods 9 are received in the openings 7 of the insulation ring 1, as known from FIG. 1. FIG. 2 shows the stator 4 with the insulation ring 1 placed on the winding head 2. These openings 7 of the insulation ring 1 are filled with a preferably electrically insulating potting compound 18, which is shown in FIG. 4.

The insulation ring 1 bears against the axial end face 17 of the stator 4 via the three spacer elements 10 extending axially out of the main body 6 of the insulation ring 1, without torques being transferable between the insulation ring 1 and the stator 4. There is therefore no circumferential positioning, no latching or other position securing between the insulation ring 1 and the stator 4 in the circumferential direction. The insulation ring 1 is thus fixed in relation to the hairpin winding 3 only via the potting compound 13 in the circumferential direction, in the radial direction and in an axial direction.

It can also be seen from FIG. 2 that the ‘twist side’ and the HV connection terminal 20 side of the hairpin winding 3 are located in the same winding head 2. In the region of the HV connection terminal, the hairpins are twisted differently than in the rest of the winding head 2, which prevents additional possible creepage distances between terminal pins and welded hairpins

As shown in FIG. 3, some of the openings 7 can also be completely or partially covered by a cover element 11. The cover element 11 is formed integrally with the insulation ring 1 or as a separate component that is fixed to the insulation ring 1. By means of a cover element 11, the creepage distances between the conductors of the winding head 2 can be extended, thereby increasing the safety with respect to undesirable local short circuits in the winding head 2.

A possible method for producing a stator 4, as known from FIGS. 2 and 4, is explained in more detail below.

First, a stator 4 is provided, wherein the stator 4 is in the shape of a cylindrical ring and a winding head 2 of a hairpin winding 3 extends axially out of the stator 4 at at least one axial end face 17.

Furthermore, an insulation ring 1 is provided, as is known from FIG. 1, the insulation ring 1 having an annular disc-shaped main body 6 with a plurality of openings 7 that extend axially through the main body 6, as well as a spacer element 10 extending out of the main body 6 at least in a first axial direction and at least one retaining element 12 extending out of the main body 6 in a second axial direction.

The insulation ring 1 is then fixed in relation to a potting tool by means of the three retaining elements 12 of the insulation ring 1 in the axial and circumferential direction.

The insulation ring 1 fixed in relation to the potting tool is then placed by the potting tool on the winding head 2 of the hairpin winding 3, so that the openings 7 are each penetrated at least in sections by the free ends 8 of a pair of hairpin conductor rods 9, and the insulation ring 1 bears against the axial end face 17 of the stator 4 via the at least one spacer element 10 extending axially out of the main body 6 of the insulation ring 1, without torques being transferable between the insulation ring 1 and the stator 4. This assembly state of the stator 4 is shown in FIG. 2, but without the potting tool.

In the attached state of the insulation ring 1, the openings 7 are then filled with a potting compound 18 using the potting tool. Finally, the potting tool is removed from the retaining elements 12 and the manufacturing state of the stator 4 shown in FIG. 4 is obtained.

It can be seen that the three retaining elements 12 of the insulation ring 1 project from the potting compound 18 in the axial direction. It would then be possible to separate the protruding retaining elements 12 so that a flat annular disc-like end surface of the potting compound 18 is created.

The disclosure is not limited to the embodiments shown in the drawings. The above description is therefore not to be regarded as limiting, but rather as illustrative. The following claims are to be understood as meaning that a stated feature is present in at least one embodiment of the disclosure. This does not exclude the presence of further features. Where the claims and the above description define ‘first’ and ‘second’ features, this designation serves to distinguish between two features of the same type without defining an order of precedence.

### LIST OF REFERENCE SIGNS

1 Insulation ring
2 Winding head
3 Hairpin winding
4 Stator
5 Electrical machine
6 Main body
7 Openings
8 Hairpin ends
9 Pair of hairpin conductor rods
10 Spacer element
11 Cover element
12 Retaining element
13 Pairs
14 Circumferential segment
15 Drivetrain
16 Motor vehicle
17 End face
18 Potting compound
19 Section
20 HV connection terminal
21 HV connection pin

1. An insulation ring for a winding head of a hairpin winding of a stator of an electrical machine within a drivetrain of a motor vehicle, comprising: an annular disc-shaped main body with a plurality of openings that extend axially through the main body and can each be penetrated at least in sections by free ends of a pair of hairpin conductor rods,
wherein at least one spacer element protrudes out of the main body in a first axial direction and at least one retaining element protrudes out of the main body in a second axial direction.

2. The insulation ring according to claim 1, wherein:
the insulation ring has at least three spacer elements and/or at least three retaining elements.

3. The insulation ring according to claim 2, wherein:
the spacer elements and/or the retaining elements are arranged equidistantly along a circumference of the insulation ring.

4. The insulation ring according to claim 2, wherein:
the spacer elements and the retaining elements each form pairs assigned to one another, which are each positioned in a common circumferential segment of the insulation ring.

5. A stator for an electrical machine within a drivetrain of a motor vehicle, wherein the stator is designed to be in a shape of a cylindrical ring and a winding head of a hairpin winding extends axially out of the stator at at least one axial end face, wherein:
the free ends of a plurality of pairs of hairpin conductor rods are received in openings of an insulation ring according to claim 1, wherein at least these openings are filled with an electrically insulating potting compound and the insulation ring bears against the axial end face of the stator via the at least one spacer element extending axially out of the main body of the insulation ring, without torques being transferable between the insulation ring and the stator.

6. The stator according to claim 5, wherein:
the at least one spacer element has no potting compound on its section contacting the stator.

7. The stator according to claim 5, wherein:
the at least one retaining element of the insulation ring projects out of the potting compound in the axial direction or is at least not covered by potting compound in a circumferential direction.

8. The stator according to claim 5, wherein:
the insulation ring is fixed in relation to the hairpin winding only via the potting compound in a circumferential direction, in a radial direction and in an axial direction.

9. A method for producing a stator for an electrical machine within a drivetrain of a motor vehicle, comprising the following steps:
providing a stator, wherein the stator is in a shape of a cylindrical ring and a winding head of a hairpin winding extends axially out of the stator at at least one axial end face,
providing an insulation ring, the insulation ring having an annular disc-shaped main body with a plurality of openings that extend axially through the main body, as well as a spacer element extending out of the main body at least in a first axial direction and at least one retaining element extending out of the main body in a second axial direction,
placing the insulation ring on the winding head of the hairpin winding so that the openings are each penetrated at least in sections by free ends of a pair of hairpin conductor rods, and the insulation ring bears against the axial end face of the stator via the spacer element extending axially out of the main body of the insulation ring, without torques being transferable between the insulation ring and the stator,
fixing a potting tool in relation to the at least one retaining element of the insulation ring in the axial direction and circumferential direction,
filling the openings with a potting compound using the potting tool, and
removing the potting tool from the at least one retaining element.

10. The method according to claim 9, wherein:
the fixing of the potting tool in relation to the at least one retaining element of the insulation ring in the axial direction and circumferential direction takes place before the insulation ring is placed on the winding head of the hairpin winding, such that the insulation ring is placed on the winding head by the potting tool.
